(19) United States
(12) Patent Application Publication
(10) Pub. No.: US 2006/0014404 A1
(43) Pub. Date: Jan. 19, 2006

(54) Sensor and method of manufacturing the same

(75) Inventors: Yota Iwamoto, Kariya-city (JP); Yoshinobu Takeuchi, Kariya-city (JP); Susumu Shibayama, Kariya-city (JP); Takamasa Yoshihara, Saitama-city (JP); Kaname Kato, Saitama-city (JP); Takeru Yamashita, Saitama-city (JP)

Correspondence Address: NIXON & VANDERHYE, PC, 901 NORTH GLEBE ROAD, 11TH FLOOR, ARLINGTON, VA, 22203, US

(73) Assignees: Denso Corporation, Kariya-city (JP); Shibaura Electronics Co., Ltd., Saitama-city (JP)

(21) Appl. No.: 11/181,818

(22) Filed: Jul. 15, 2005

(30) Foreign Application Priority Data
Jul. 15, 2004 (JP) 2004-208984

(51) Int. Cl. H01R 12/00

(52) U.S. Cl. 439/76.2

(57) ABSTRACT

A sensor is provided with a sensing unit for generating electrical signals responding to a physical quantity, multiple terminals for an electrical connection with an external, multiple signal wires for transmitting the electrical signals to the terminals, a connector housing where the terminals are accommodated, and an electrically isolating case, to which the terminals are fixed. The terminals and the electrically isolating case are inserted into the connecter housing. Thus, the connecter housing can be singly formed without being insert-molded. Accordingly, the manufacture performance of the sensor can be improved.

### CROSS REFERENCE TO RELATED APPLICATION

This application is based on Japanese Patent Application No. 2004-208984 filed on Jul. 15, 2004, the disclosure of which is incorporated herein by reference.

### FIELD OF THE INVENTION

The present invention relates to a sensor and a method of manufacturing the sensor.

### BACKGROUND OF THE INVENTION

Generally, as shown in FIG. 11, a sensor is provided with a sensing unit (not shown) for generating electrical signals responding to a physical quantity, terminals 50 for electrically connecting with the external, a connector housing 40 and the like, for example, referring to JP-2003-302292A. The terminals 50 are accommodated in the connector housing 40, which is inserted into a housing 10. The sensing unit is arranged in a protection tube 30.

In this case, the connector housing 40 is insert-molded, while the components of the sensor other than the connector housing 40 are beforehand assembled. In order to properly set the position relation between the connector housing 40 and the terminals 50, the terminals 50 are fixed in a die of the connector housing 40. Then, a resin is injected into the die to form the connector housing 40.

However, it is difficult to insert the terminals 50 in the die for forming the connector housing 40. Therefore, the manufacture performance of the sensor is impaired.

### SUMMARY OF THE INVENTION

In view of the above-described disadvantages, it is an object of the present invention to provide a sensor and a method of manufacturing the sensor to improve a manufacture performance of the sensor.

According to an aspect of the present invention, a sensor includes a sensing unit for generating electrical signals responding to a physical quantity, a plurality of terminals for an electrical connection with an external, a plurality of signal wires for transmitting the electrical signals to the terminals, a connector housing in which the terminals are accommodated, and an electrically isolating case, to which the terminals are fixed. The terminals and the electrically isolating case are inserted in the connecter housing.

Because the multiple terminals are fixedly connected to the single electrically isolating case, the terminals can be readily inserted into the connector housing. Moreover, because the terminals and the electrically isolating case are to be inserted in the connector housing, the connector housing can be singly formed without being insert-molded. That is, it is unnecessary to insert the terminals in a die when the connector housing is formed. Accordingly, the manufacture performance of the sensor can be improved.

According to another aspect of the present invention, a sensor includes a sensing unit for generating electrical signals responding to a physical quantity, a plurality of terminals for an electrical connection with an external, a plurality of signal wires for transmitting the electrical signals to the terminals, a connector housing in which the terminals are accommodated, a plurality of junction portions made of a metal, and an electrically isolating case, to which the junction portions are fixed. The terminals and the signal wires are joined to the junction portions. The terminals and the electrically isolating case are inserted in the connecter housing.

Because the multiple terminals are fixedly connected to the single isolating case through the junction portions, the terminals can be readily inserted into the connector housing. Moreover, because the terminals and the isolating case are to be inserted in the connector housing, the connector housing can be singly formed without being insert-molded. It is unnecessary to insert the terminals in the die when the connector housing is formed. Accordingly, the manufacture performance of the sensor can be improved.

Moreover, in this case, the heat capacity of the junction portion can be set as an intermediate valve between the heat capacity of the terminal and that of the signal wire. Therefore, the junction portion can be joined to both the signal wire and the terminal. Accordingly, the terminals and the signal wires can be electrically connected with each other through the junction portions, even if the heat-capacity difference between the terminals and the signal wires is large.

According to more another aspect of the present invention, a manufacturing method is provided for a sensor which includes a sensing unit for generating electrical signals responding to a physical quantity, a plurality of terminals for an electrical connection with an external, a plurality of signal wires for electrically connecting the sensing unit to the terminals, a connector housing, a plurality of junction portions made of a metal, and an electrically isolating case. The method includes forming the connector housing, insert-molding the electrical isolating case by a die, in which the junction portions are beforehand arranged, joining the terminals and the signal wires to the junction portions after the step of insert-forming, and inserting the terminals and the electrically isolating case in the connector housing after the step of joining.

Thus, the sensor can be suitably manufactured.

Preferably, the method of manufacturing the sensor includes preparing a terminal member which is constructed of a connection portion and the terminals before the step of joining. The terminals are arranged with a predetermined position relation and connected with each other through the connection portion. The connection portion is to be separated from the terminals after the terminals are joined to the junction portions at the step of joining.

Because the connection portion is separated from the terminals after the terminals are joined to the junction portions, the predetermined position relation among the multiple terminals can be properly maintained, as compared with the case where the multiple terminals are singly joined to the junction portions.

### BRIEF DESCRIPTION OF THE DRAWINGS

Other objects, features and advantages of the present invention will become more apparent from the following detailed description made with reference to the accompanying drawings, in which:

FIG. 1 is a partially cross-sectional view showing a whole construction of a temperature sensor according to a first embodiment of the present invention;

FIG. 2 is a plan view showing a case forming process of the temperature sensor according to the first embodiment;

FIG. 3A is a plan view showing a junction member 60A, and FIG. 3B is a cross-sectional view taken along a line IIIB-IIIB in FIG. 3A;

FIG. 4 is a partially cross-sectional view showing a first joining process of the temperature sensor according to the first embodiment;

FIG. 5A is a plan view showing a second joining process of the temperature sensor according to the first embodiment, and FIG. 5B is a cross-sectional view taken along a line VB-VB in FIG. 5A;

FIG. 6 is a plan view showing a terminal member 50A according to the first embodiment;

FIG. 7A is a partially cross-sectional view showing an inserting process of the temperature sensor according to the first embodiment, and FIG. 7B is a partially cross-sectional view taken along a line VIIB-VIIB in FIG. 7A;

FIG. 8 is a cross-sectional view showing a connector housing 40 according to the first embodiment;

FIG. 9 is a plan view showing a case forming process of a temperature sensor according to a second embodiment of the present invention;

FIG. 10 is a partially cross-sectional view showing a joining process of the temperature sensor according to the second embodiment; and

FIG. 11 is a partially cross-sectional view showing a whole construction of a temperature sensor according to a related art.

### DETAILED DESCRIPTION OF THE PREFERRED EMBODIMENTS

(First Embodiment)

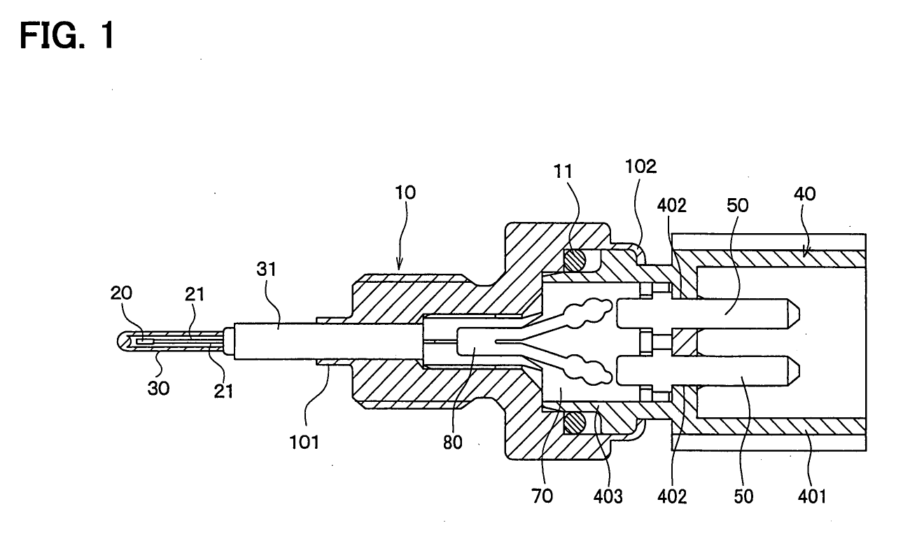

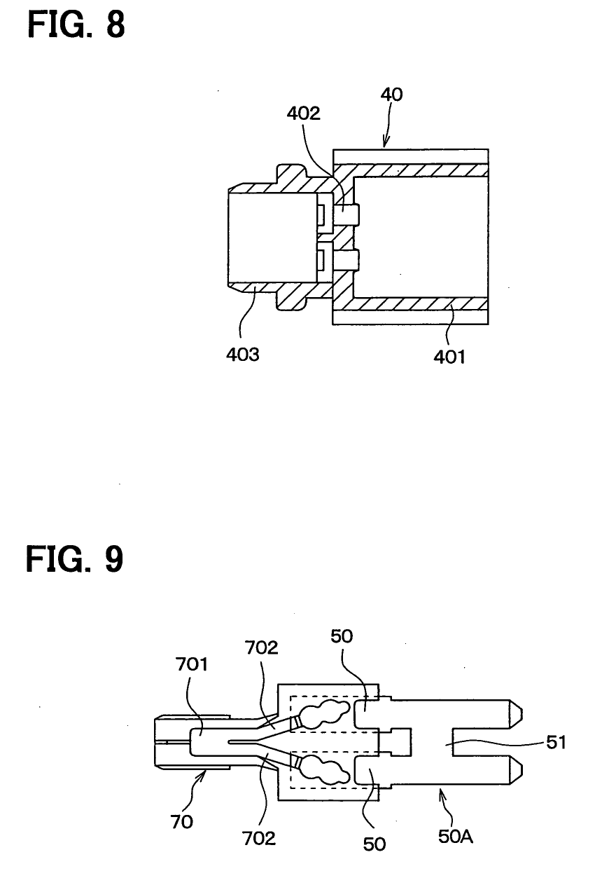

A first embodiment of the present invention will be described with reference to FIGS. 1-8. As shown in FIG. 1, a sensor is provided with a sensing unit 20 for generating electrical signals responding to a physical quantity (e.g., temperature), multiple terminals 50 for an electrically connection with the external, multiple signal wires 21 for electrically connecting the sensing unit 20 to the multiple terminals 50, a housing 10, a connector housing 40, an electrically isolating case 70 and the like.

The sensing unit 20 (e.g., thermistor element) is made of, for example, a ceramic, a silicon semiconductor or the like, so that the resistance thereof is variable responding to a temperature and the sensor is suitably used for a temperature sensor.

The housing 10 having a stepped cylinder shape is made of a metal (e.g., stainless steel). The sensing unit 20, being disposed at the side of one end of the housing 10, is accommodated in a tubular protection unit 30 which is made of a metal, for example. The protection unit 30 has a bottomed cylindrical shape with one end opened and other end closed. The protection unit 30 is inserted through a cylinder-tubular support unit 31, which is made of a metal. The protection unit 30 and the support unit 31 are integrated by brazing or the like, and inserted into a welding cylinder portion 101, which is located at the one end of the housing 10. The support unit 31 is joined to the welding cylinder portion 101 by, for example, laser welding.

The cylindrical connector housing 40 is made of, for example, a resin. One end (insertion end) of the cylindrical connector housing 40 is inserted into (engaged with) other end of the housing 10. The housing 10 is swaged (crimped) toward the diametrically inner side thereof to construct a swaged portion 102, which is located at the other end of the housing 10 and at the axially outer side of the insertion end of the cylindrical connector housing 40. Thus, the connector housing 40 is fixedly connected with the housing 10.

An O-ring 11, being arranged around the insertion end of the connector housing 40, is engaged with both the inner surface of the housing 10 and the outer surface of the insertion end of the connector hosing 40 to seal therebetween.

The sensing unit 20 is electrically connected with the signal wires 21 (e.g., two signal wires 21). The signal wire 21, being covered with a sheathing tube (not shown), is electrically connected to the terminal 50 through a junction portion 60. The multiple terminals 50 (e.g., two terminals 50) and the multiple junction portions 60 (e.g., two junction portions 60) are made of metals. Thus, the electrical signals generated by the sensing unit 20 can be transmitted to the terminals 50 through the signal wires 21 and the junction portions 60.

The junction portions 60 and the terminals 50 are fixed to the electrically isolating case 70. The terminals 50 and the electrically isolating case 70 (isolating case 70) are inserted in the connector housing 40.

Next, the method of manufacturing the temperature sensor with the above-described construction will be described.

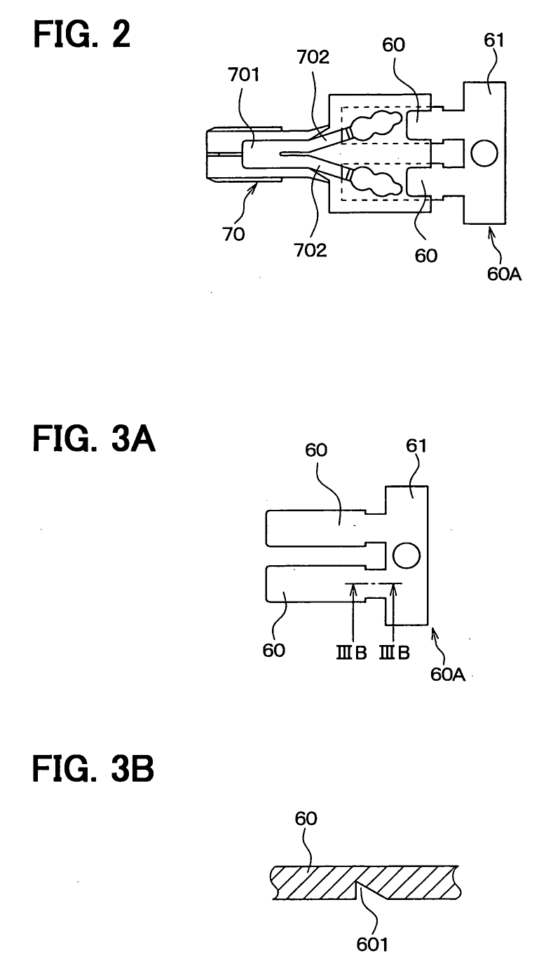

At first, referring to FIG. 2, the isolating case 70 will be formed in a case forming process. Before the case forming process, a junction member 60A made of a metal (e.g., stainless steel) is prepared as shown in FIG. 3A. The junction member 60A includes a connection portion 61 and the two junction portions 60 with a plate shape, for example. The junction portions 60, extending parallel to each other, are connected with each other through the connection portion 61. Referring to FIG. 3B, each of the junction portions 60 is provided with a notch 601, which is positioned near the connection portion 61. Thus, the connection portion 61 can be readily separated from the junction portions 60 at the later-described process.

Then, at the case forming process, the junction member 60A is arranged in a die (not shown) of the isolating case 70. Thereafter, an electrically isolating resin such as a polyphenylene sulfide (PPS) is injected into the die, so that the isolating case 70 is insert molded. In this case, parts of the junction portions 60 are embedded in the isolating case 70.

After the isolating case 70 is formed, the connection portion 61 is bent at the notch 601, to be separated from the junction portions 61. Therefore, the two junction portions 60 are electrically separated from each other.

The isolating case 70 is provided with a tube insertion groove 701 in which the protection unit 30 is to be inserted, and a pair of wire insertion grooves 702 in which the signal wires 21 are respectively to be inserted. The junction portions 60 are partly exposed in the wire insertion groove 702.

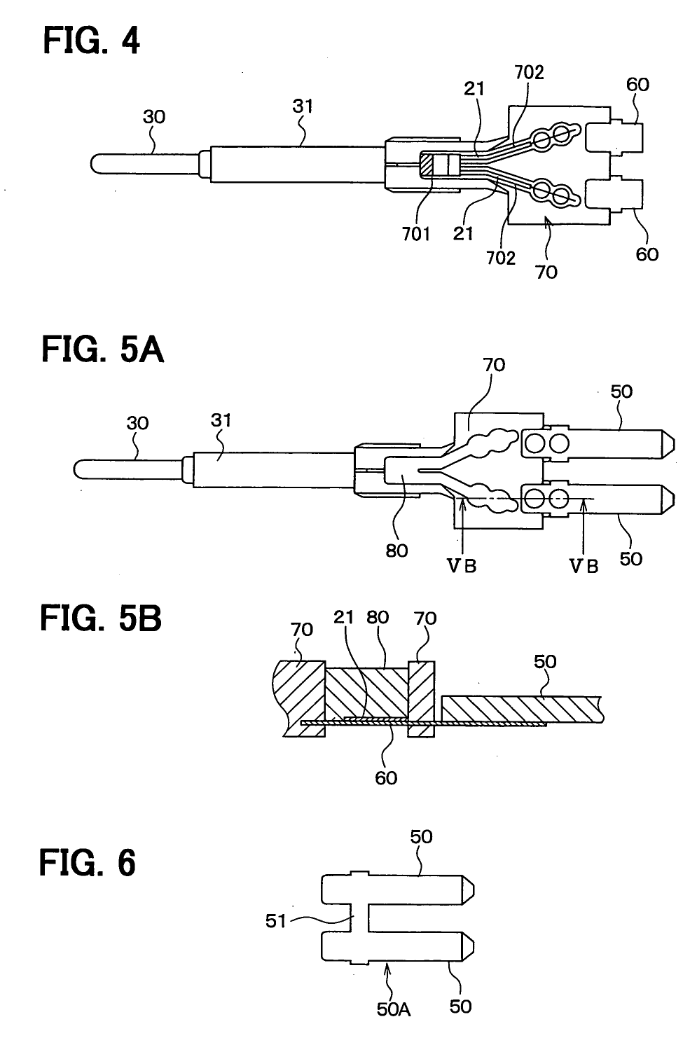

Referring to FIG. 4, after the isolating case 70 is insert-molded at the case forming process, the signal wires 21 and the terminals 50 will be joined to the junction portions 60 respectively at a first joining process and a second joining process.

Specifically, at the first joining process, the protection unit 30 where the sensing unit 20 is accommodated is inserted in the tube insertion groove 701 of the insulating case 70. The signal wires 21 are respectively inserted in the wire insertion grooves 702 of the isolating case 70. In the wire insertion groove 702, the signal wires 21 are respectively joined to the junction portions 60 by a spot welding or the like.

Then, after the first joining process, the terminals 50 will be respectively connected to the junction portions 60 at the second joining process, referring to FIGS. 5A and 5B. Before the second joining process, a terminal member 50A is prepared as shown in FIG. 6. The terminal member 50A includes the two terminals 50 which are arranged with a predetermined position relation, and a connection portion 51 connecting the terminals 50 to each other. Preparing the terminal member 50A can be also performed at any time (e.g., before first joining process) before the second joining process.

Thus, at the second joining process, the terminals 50 of the terminal member 50A are respectively joined to the junction portions 60 by a spot welding or the like. Thereafter, the connection portion 51 is separated from the terminals 50, so that the terminals 50 are divided from each other. Then, the tube insertion groove 701 and the wire insertion grooves 702 of the isolating case 70 are filled with an epoxy resin or the like. Thus, a resin layer 80 is formed at the isolating case 70, to fix the junction portions 60 and the terminals 50 to the isolating case 70.

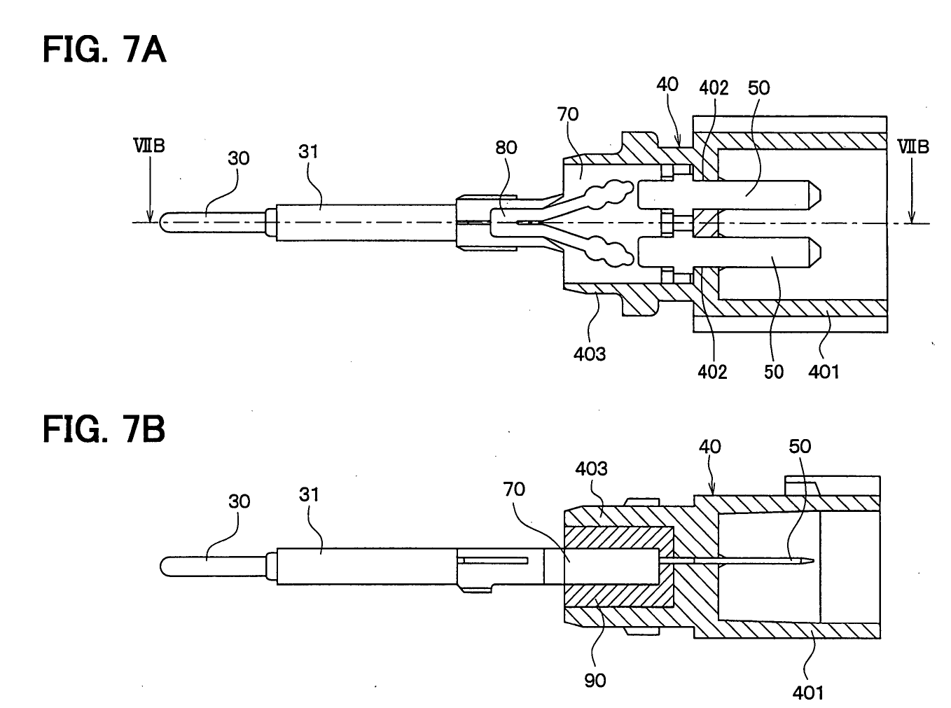

After the second joining process, the terminals 50 and the isolating case 70 will be inserted into the connector housing 40 at an inserting process with reference to FIGS. 7A and 7B.

Before the inserting process, the cylindrical connector housing 40 is prepared (formed) at a connector housing forming process. Referring to 8, the connector housing 40, being made of an electively isolating resin such as a polyphenylene sulfide (PPS), is formed to include a connector engagement cylinder portion 401 and a case engagement cylinder portion 403. The connector engagement cylinder portion 401 and the case engagement cylinder portion 403 are sequentially arranged in an axial direction of the connector housing 40, and communicated with each other by two penetration holes 402. The penetration holes 402, extending in the axial direction of the connector housing 40, penetrate the partition wall between the connector engagement cylinder portion 401 and the case engagement cylinder portion 403.

The connector housing forming process can be also performed at any time (e.g., before case forming process) before the inserting process, to prepare the connector housing 40.

Then, at the inserting process, while the tips of the two terminals 50 are respectively positioned to correspond to the penetration holes 402, the terminals 50 and the isolating case 70 are press-inserted into the connector housing 40. Thus, the terminals 50 are inserted through the penetration holes 402, so that ends of the terminals 50 protrude into the connector engagement cylinder portion 401. The isolating case 70 is engaged with the case engagement portion 403. The connector engagement cylinder portion 401 of the connector housing 40 is to be engaged with a housing (not shown) of other connector.

Thereafter, an epoxy resin or the like is supplied to the case engagement cylinder portion 403, to form a resin layer 90 which seals the overlapping part between the isolating case 70 and the case engagement cylinder portion 403. Thus, the isolating case 70 is fixed to the connector housing 40 through the resin layer 90.

Thus, the assembly having the above-described construction is inserted into the housing 10. In this case, the protection unit 30 and the support unit 31 are inserted through the welding cylinder portion 101 of the housing 10 to protrude from the housing 10. Thereafter, the housing 10 is swaged at the swaged portion 102 toward the diametrically inner side of the housing 10. The welding cylinder portion 101 is joined to the support unit 31. Thus, the temperature sensor shown in FIG. 1 is manufactured.

According to this embodiment, because the two terminals 50 are fixedly connected to the single isolating case 70 through the junction portions 60, the two terminals 50 can be readily inserted into the connector housing 40. Moreover, because the terminals 50 and the isolating case 70 are to be inserted in the connector housing 40 after it is manufactured, the connector housing 40 can be singly formed without being insert-molded. That is, it is unnecessary to insert the terminals 50 in the die when the connector housing 40 is formed. Accordingly, the manufacture performance of the sensor can be improved.

In the case where the heat-capacity difference between the terminal 50 and the signal wire 21 is large, it may be unfeasible to join the signal wire 21 to the terminal 50 by soldering, welding or the like. According to this embodiment, the heat capacity of the junction portion 60 is set as an intermediate valve between the heat capacity of the terminal 50 and that of the signal wire 21. Therefore, the junction portion 60 can be joined to both the signal wire 21 and the terminal 50. Accordingly, the terminals 50 and the signal wires 21 can be electrically connected with each other through the junction portions 60.

Furthermore, according to this embodiment, the terminal member 50A including the two terminals 50 and the connection portion 51 is prepared. The terminals 50 are arranged with the predetermined position relation and connected with each other through the connection portion 51, which is to be separated from the terminals 50 after the terminals 50 are joined to the junction portions 60. Therefore, the predetermined position relation between the two terminals 50 can be maintained even after the connection portion 51 is separated. Accordingly, the joining process of the terminal 50 is simplified.

(Second Embodiment)

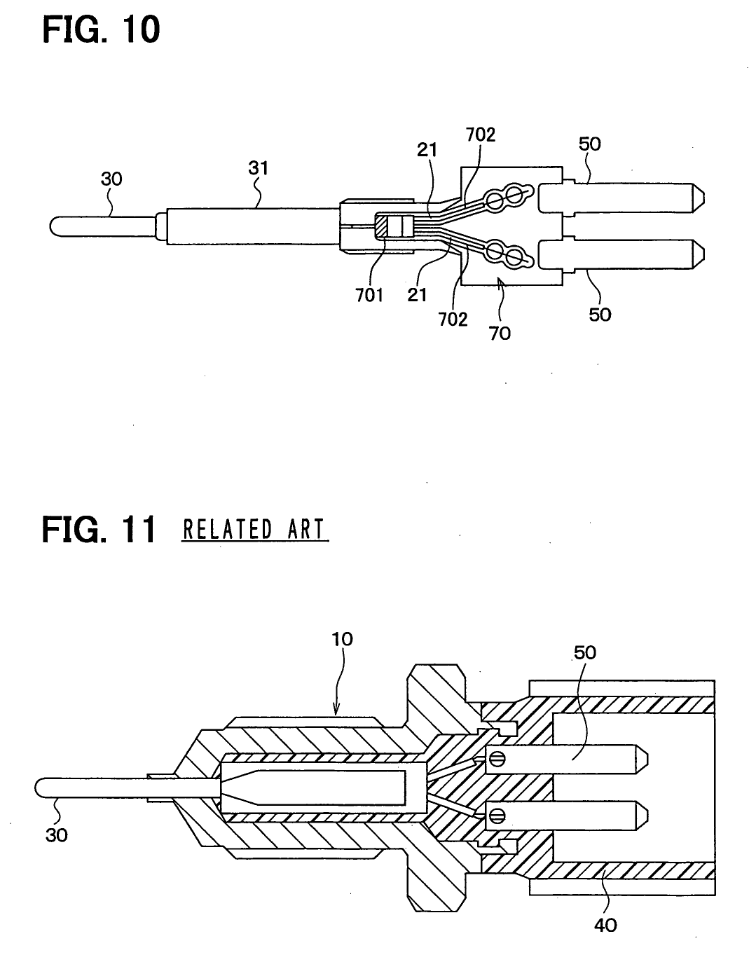

A second embodiment of the present invention will be described referring to FIGS. 9 and 10.

In the above-described first embodiment, the junction portions 60 are fixed to the isolating case 70. The terminals 50 and the signal wires 21 are joined to the junction portions 60. According to the second embodiment, the terminals 50 are fixed to the single isolating case 70, and the signal wires 21 are respectively joined to the terminals 50.

Specifically, as shown in FIG. 9, at the case forming process, the terminal member 50A is arranged in the die (not shown) of the isolating case 70. Then, the electrically isolating resin is injected into the die, and the isolating case 70 is insert-molded. In this case, the terminal member 50A (terminals 50) is partly embedded in the isolating case 70, and partly exposed at the wire insertion groove 702. Thereafter, the connection portion 51 is separated from the terminals 50, so that the two terminals 50 are separated from each other.

Then, as shown in FIG. 10, at the joining process, the signal wires 21 are respectively joined to the terminals 50 which are partly exposed at the wire insertion groove 702. Thereafter, the epoxy resin is supplied to the tube insertion groove 701 and the wire insertion grooves 702 of the isolating case 70.

Next, similarly to the first embodiment, the terminals 50 and the isolating case 70 are inserted into the connector housing 40, and the connector housing 40 is fixed to the housing 10.

According to this embodiment, the two terminals 50 are fixedly connected to the single isolating case 70, so that the terminals 50 can be readily inserted in the connector housing 40. Moreover, because the terminals 50 and the isolating case 70 are to be inserted into the connector housing 40 after it is manufactured, the connector housing 40 can be singly formed without being insert-molded. Accordingly, it is unnecessary to insert the terminals 50 in the die of the connector housing 40 when the connector housing 40 is formed. Therefore, the manufacture performance of the sensor can be improved.

Moreover, according to this embodiment, the terminal member 50A including the two terminals 50 and the connection portion 51 is prepared. The terminals 50 are arranged with the predetermined position relation, and connected with each other through the connection portion 51, which will be separated from the terminals 50 after the terminals 50 are joined to the isolating case 70. Therefore, the predetermined position relation between the two terminals 50 can be maintained even after the connection portion 51 is separated. Thus, the joining process of the terminals 50 is simplified.

The construction of the sensor and the method of manufacturing the sensor, which have not been described in the second embodiment, are the same with those in the first embodiment.

(Other Embodiment)

Although the present invention has been fully described in connection with the preferred embodiments thereof with reference to the accompanying drawings, it is to be noted that various changes and modifications will become apparent to those skilled in the art.

In the above-described embodiments, the sensor and the manufacturing method thereof are suitably used for the temperature sensor. However, the sensor and the manufacturing method thereof according to the present invention can be also used for other sensors.

Such changes and modifications are to be understood as being in the scope of the present invention as defined by the appended claims.

What is claimed is:

1. A sensor comprising:
a sensing unit for generating electrical signals responding to a physical quantity;
a plurality of terminals for an electrical connection with an external;
a plurality of signal wires for electrically connecting the sensing unit to the terminals;
a connector housing, in which the terminals are accommodated; and
an electrically isolating case, to which the terminals are fixed, wherein
the terminals and the electrically isolating case are inserted in the connecter housing.

2. The sensor according to claim 1, wherein the electrically isolating case is made of a resin.

3. The sensor according to claim 1, wherein the connector housing is made of a resin.

4. A sensor comprising:
a sensing unit for generating electrical signals responding to a physical quantity;
a plurality of terminals for an electrical connection with an external;
a plurality of signal wires for electrically connecting the sensing unit to the terminals;
a connector housing, in which the terminals are accommodated;
a plurality of junction portions made of a metal; and
an electrically isolating case, to which the junction portions are fixed, wherein:
the terminals and the signal wires are joined to the junction portions; and
the terminals and the electrically isolating case are inserted in the connecter housing.

5. The sensor according to claim 4, further comprising:
a cylindrical housing;
a tubular support unit; and
a tubular protection unit, wherein:
the sensing unit is accommodated in the protection unit, which is inserted through the support unit;
the protection unit and the support unit are inserted into one end of the housing; and
the connector housing is inserted into other end of the housing.

6. The sensor according to claim 5, wherein:
the electrically isolating case has a tube insertion groove in which the protection unit is inserted, and multiple wire insertion grooves in which the signal wires are respectively inserted; and
the junction portions are respectively electrically connected with the signal wires in the wire insertion grooves.

7. A method of manufacturing a sensor which includes a sensing unit for generating electrical signals responding to a physical quantity, a plurality of terminals for an electrical connection with an external, a plurality of signal wires for electrically connecting the sensing unit to the terminals, a connector housing, a plurality of junction portions made of a metal, and an electrically isolating case, the method comprising:
forming the connector housing;
insert-molding the electrical isolating case by a die, in which the junction portions are beforehand arranged;
joining the terminals and the signal wires to the junction portions after the step of insert-forming; and
inserting the terminals and the electrically isolating case in the connector housing after the step of joining.

8. The method of manufacturing the sensor according to claim 7, further comprising
preparing a terminal member constructed of a connection portion and the terminals before the step of joining, the terminals being arranged with a predetermined position relation and connected with each other through the connection portion, wherein
the connection portion is to be separated from the terminals after the terminals are joined to the junction portions at the step of joining.

9. The method of manufacturing the sensor according to claim 7, further comprising
preparing a junction member constructed of a connection portion and the junction portions before the step of insert-molding, the junction portions extending parallel to each other and connected with each other through the connection portion, wherein
the connection portion is to be separated from the junction portions after the electrical isolating case is formed at the step of insert-molding.

10. The method of manufacturing the sensor according to claim 9, wherein each of the junction portions has a notch, which is positioned near the connection portion.
